(19) United States
(12) Patent Application Publication
(10) Pub. No.: US 2004/0101184 A1
(43) Pub. Date: May 27, 2004

(54) Automatic contouring of tissues in CT images

(76) Inventors: Radhika Sivaramakrishna, Union City, CA (US); John S. Birbeck, Syracuse, UT (US); Cliff E. Frieler, Farmington Hills, MI (US); Robert M. Cothren, Walnut Creek, CA (US)

Correspondence Address: William Blake, Jones, Tullar & cooper, PC, P.O. Box 2266 Eads Station, Arlington, VA, 22202, US

(21) Appl. No.: 10/304,005

(22) Filed: Nov. 26, 2002

(51) Int. Cl. G06K 9/00

(52) U.S. Cl. 382/131

(57) ABSTRACT

An automated method and system for autocontouring organs and other anatomical structures in CT and other medical images employs one or more contouring techniques, depending on the particular organs or structures to be contoured. In a preferred embodiment, an edge-based technique is employed to contour one or more organs. A multiple hypothesis testing technique can be employed to improve the accuracy of the resulting contour. Independent algorithms can be employed for contouring multiple organ in a given region, such as the male pelvic region. An integration algorithm can be employed to combine the results of the independent algorithms to improve accuracy further.

### BACKGROUND OF THE INVENTION

1. Field of the Invention

The present invention relates in general to a method and system for automatically contouring tissues and other anatomic structures in CT or other medical images. The method and system employ algorithms using edge detection and other techniques to identify boundaries of anatomic structures, such as organs.

2. Description of the Background Art

Radiation treatment is often used to treat various forms of cancer. Modern radiation treatment techniques, such as intensity-modulation radiation therapy (IMRT), are capable of preferentially concentrating radiation in specific cancerous tissues in the body while limiting damage to nearby normal tissues. However, in order for this these techniques to be effective, a physician or other highly trained individual must accurately identify which tissues are to be treated and which are to be avoided. As a result, current methods of radiation treatment planning require the physician or other highly trained individual to outline each of several tissues within a 3D CT image set manually in order to identify the tissues to be treated and the tissues to be avoided.

This outlining procedure is referred to as contouring and is a very lengthy, inexact method, especially when employed with certain types of cancer. For example, a particularly prominent form of cancer in males, prostate cancer, is problematic in this regard because of the close proximity of the prostate to other organs including the bladder, the rectum and the seminal vesicles, and because of the nearly uniform density of these tissues to X-rays. As a result, a male's pelvic region typically appears in a CT image as an almost uniformly gray region in which the aforementioned organs cannot be readily distinguished from one another.

To address the foregoing problem, researchers have investigated using computerized contouring techniques that automatically identify the contours of the various organs or other objects in a CT or other image. These autocontouring techniques seek to provide higher accuracy than has been previously achieved, which is especially important with IMRT. Unfortunately, the prior art approaches to such autocontouring techniques employ 2D and 3D region growing, which is an area-based technique. This approach has not been found robust enough for clinical use and has no current commercial application. As a result, a need still remains for a commercially viable autocontouring technique that can be employed to identify accurately, contours of organs and other anatomical structures in CT images or the like.

### SUMMARY OF THE INVENTION

The present invention addresses the foregoing need through provision of an autocontouring algorithm that can be used to contour organs and other anatomical structures in CT and other medical images. The algorithm employs one or more contouring techniques, depending on the particular organs or structures to be contoured. In a preferred embodiment, an edge-based technique operates by first locating in an image, an interior point that is determined to be within an organ or structure to be contoured. A number of radial projections of the image gradient are then computed for each of a number of points radiating in a number of directions from the interior point. Whenever the gradient value decreases to a sufficient extent, this is an indication that the point along the radial projection where this occurs potentially represents an edge of the organ or structure. Once these edge points are identified, an outline of the organ or structure can be obtained by connecting the edge points of adjacent radial projections together.

For any radial projection along which no such edge points are located, which can occur when the edge of the organ or structure in a particular portion of an image is not clear, for example, a median point between the points on either adjacent projection, can be selected. In addition, in some cases, a number of such points may be found along one or more of the radial projections. This can happen, for example, when the object being contoured is not uniform in appearance. In this instance, a technique known as multiple hypothesis testing (MHT) can be applied in which multiple combinations of the edge points are analyzed and compared against known characteristics of the organ or other structure being contoured. Combinations of the points that do not satisfy the requisite characteristics are eliminated until one final set remains that is determined to be the most likely contour of the actual boundary of the organ or structure. This MHT process can also be employed in any other anatomic structure contouring identification technique in which multiple combinations of image points have been determined to represent potential contours, but only one such combination actually represents a desired contour.

In a preferred embodiment of the present invention that is specifically designed for autocontouring the organs in a male's pelvis, the autocontouring algorithm comprises sub-algorithms that are used to contour the four primary organs of interest in the male pelvis, namely the prostate, bladder, rectum and seminal vesicles. The sub-algorithms for the prostate, bladder and rectum operate independently, though each of them employs the aforementioned edge detection technique in which coordinates of an internal point in each of the three organs is first specified. Using this information, the three algorithms find edges corresponding to the borders of these organs by searching for radial gradient minima formulated in 3D meeting certain gray level criteria. Once an initial contouring is achieved, it is improved by resolving slice-to-slice ambiguities and discontinuities. Missing edges are filled in or interpolated using gradient information in adjacent radials. The segmentation results for these three organs are used with information on pelvic bone orientation to find the seminal vesicles. Once the four organs are contoured, conflicts and intersections between the organs are resolved in a final integration step.

### BRIEF DESCRIPTION OF THE DRAWINGS

The features and advantages of the present invention will become apparent from the following detailed description of a preferred embodiment thereof, taken in conjunction with the accompanying drawings, in which:

FIG. 1 is a block diagram of a system for analyzing CT volume images in accordance with a preferred embodiment of the present invention;

FIG. 2 is a copy of a CT image slice showing the cross section of a male pelvic region in an area near the cranial-most extent of the pubic symphysis;

FIG. 3 is a copy of a CT image slice showing the cross section of a male pelvic region in an area near the caudal-most extent of the pubic symphysis;

FIG. 4 is a flowchart for a sub-algorithm that is employed in the preferred embodiment for locating the pubic symphysis in a CT image slice of a male's pelvic region;

FIG. 5 is a flowchart for a sub-algorithm that is employed in the preferred embodiment for locating bone and muscle structures in a CT image slice of a male's pelvic region;

FIG. 6 is a flowchart for a sub-algorithm that is employed in the preferred embodiment for locating the contour of the bladder in a CT image slice of a male's pelvic region;

FIG. 7 is a flowchart for a sub-algorithm that is employed in the preferred embodiment for locating the contour of the rectum in a CT image slice of a male's pelvic region;

FIG. 8 is a flowchart for a sub-algorithm that is employed in the preferred embodiment for locating the contour of the prostate in a CT image slice of a male's pelvic region;

FIG. 9 is a flowchart for a sub-algorithm that is employed in the preferred embodiment for locating the seminal vesicles in a CT image slice of a male's pelvic region;

FIG. 10 is a flowchart for a sub-algorithm that is employed in the preferred embodiment for integrating the results obtained by the other sub-algorithms; and

FIGS. 11-15 are copies of CT image slices in which organs and other anatomical structures have been contoured or identified using the preferred embodiment of the present invention.

### DETAILED DESCRIPTION OF A PREFEREED EMBODIMENT

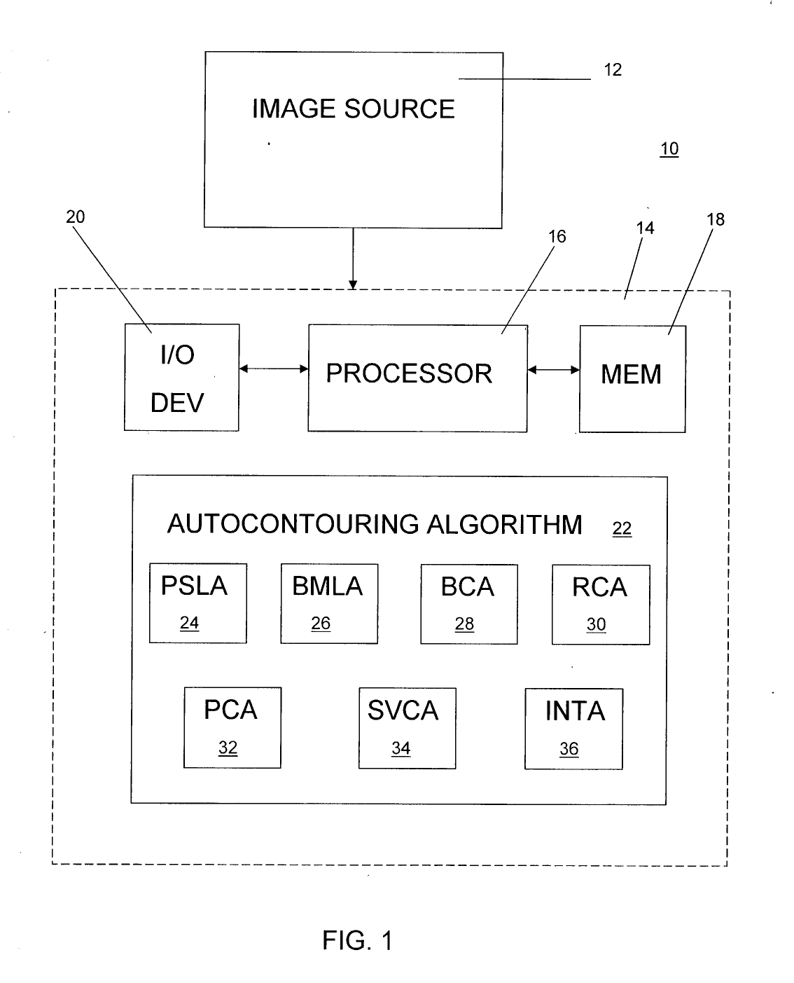

FIG. 1 illustrates a CT image analysis system 10 for generating and contouring 3D volume images in accordance with a preferred embodiment of the present invention. The preferred embodiment is specifically designed to contour the organs in a male's pelvic region, although it should be understood that the invention could also be employed to contour images of other anatomic organs or structures. In addition, although the preferred embodiment is designed specifically for analyzing CT images, it should be understood that the invention could also be employed for analyzing other types of medical images, such as MRI, ultrasound, etc.

In the preferred embodiment, the system 10 includes a source 12 of CT 3 -dimensional volume images of a person's body. The source 12 can be any suitable system or device for storing CT images, such as for example, a remote network or database that may be accessed in any known manner, such as over the Internet, or a removable storage device. As is conventional, each of the 3D volume images is a digital image that is formed of an array of 3D pixels known as voxels. Each voxel is assigned a gray level value that identifies the voxel's relative brightness in a range between black and white. The intensity information in CT images is quantitative, meaning that the gray-level value is consistent among patients and has meaning in terms of the tissue's X-ray density. It therefore is useful to segment different types of tissues, for example bone, muscle and fat, simply on their gray-level values.

The 3D volume images are separated into 2-dimensional multiple pixel image slices and are fed into a programmable computer 14, which can be any suitable computer, such as a PC. As is conventional, the computer 14 includes a processor 16, a memory 18 and a number of conventional I/O devices 20, which can include a keyboard, a mouse, a monitor, a printer, etc. As images are transferred from the source 12, they are input into the computer 14 and stored in the memory 18 for subsequent analysis.

To carry out this analysis, the processor 16 is programmed to analyze each image slice through execution of an autocontouring algorithm 22. In the preferred embodiment that is specifically designed for contouring or segmenting the organs in a male pelvis, the autocontouring algorithm 22 is employed for contouring the bladder, rectum, prostate and seminal vesicles with a minimum of user input. The algorithm 22 includes a number of sub-algorithms including a pubic symphysis locating algorithm 24; a bone and muscle locating algorithm 26 for locating various bone and muscle structures in the pelvis, including the femoral heads, the coccyx and the obturator internus; a bladder contouring algorithm 28; a rectum contouring algorithm 30; a prostate contouring algorithm 32; a seminal vesicle contouring algorithm 34; and, an integration algorithm 36 for resolving overlaps that are generated by the between the various organs. The overall strategy is to contour the bladder, rectum and prostate independently, then contour the seminal vesicles making use of the contours of these first three organs. Finally, the integration algorithm 36 resolves conflicts between the four contouring steps and produces a final result. The details of each of the sub-algorithms are set forth in the description that follows.

At the outset, it should be noted that distances are recited in the various sub algorithms in terms of pixel distances. Also, much of the analysis proceeds on a slice-by-slice basis. In the preferred embodiment, the pixel size in the x-y plane ranges anywhere from 0.820 to 0.938 mm and the slice thickness is 3.00 mm.

The autocontouring algorithm 22 starts by executing the pubic symphysis locating algorithm 24 and the bone and muscle locating algorithm 26, which are sub-algorithms that determine the locations in an input CT image of reference points that are used by the various organ contouring algorithms. The pubic symphysis locating algorithm 24 finds the cranial-most extent, center and caudal-most extent of the pubic symphysis. This information is useful because the prostate starts caudally near the cranial-most point on the pubic symphysis and slices are not analyzed caudal to the pubic symphysis for either rectum or prostate contouring. The center of the pubic symphysis is also used by bone and muscle locating algorithm 26 to locate various other anatomic structures in the pelvic region. The pubic symphysis is the joint between the two halves of the pelvis along the front. The joint is held together by the pubic arcuate ligament. Thus, in a CT image, the pubic symphysis is the gap between the bones and typically extends across several slices. The analysis carried out by the pubic symphysis locating algorithm 24 goes caudally to cranially (i.e., bottom to top), although this direction is arbitrary and the analysis can go either direction.

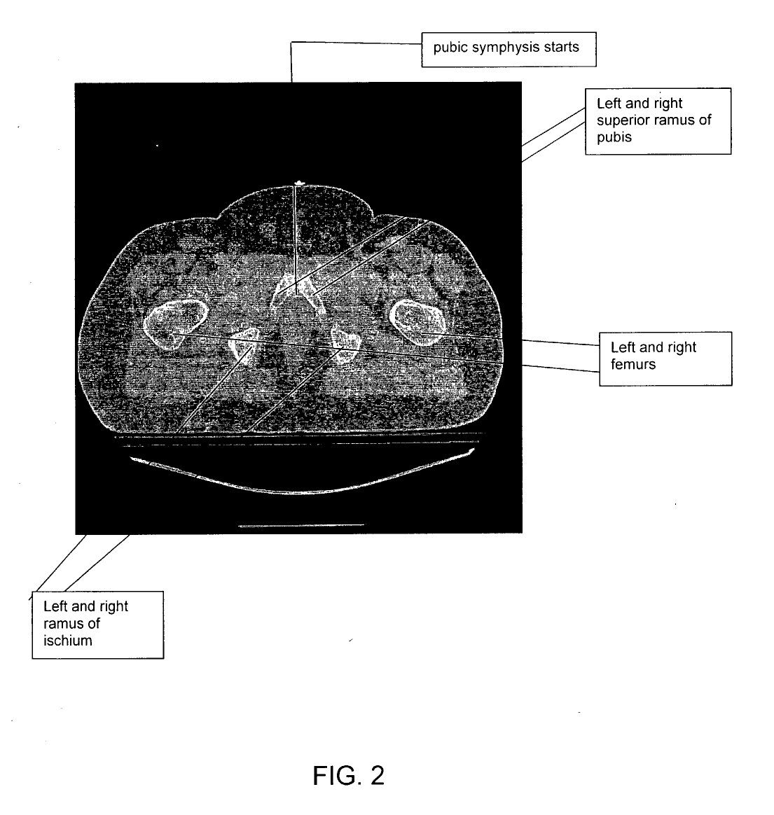

As the analysis is performed slice by slice, the number of significant bone segments is different in each slice. Usually at the caudal end of the pubic symphysis, six major bone segments are present in the image slice: the left and right superior ramus of pubis (part of the pubic bone), the left and right ramus of ischium and the left and right femur. The image slice in FIG. 2 shows a typical arrangement of bone segments in a slice at the caudal end of the pubic symphysis.

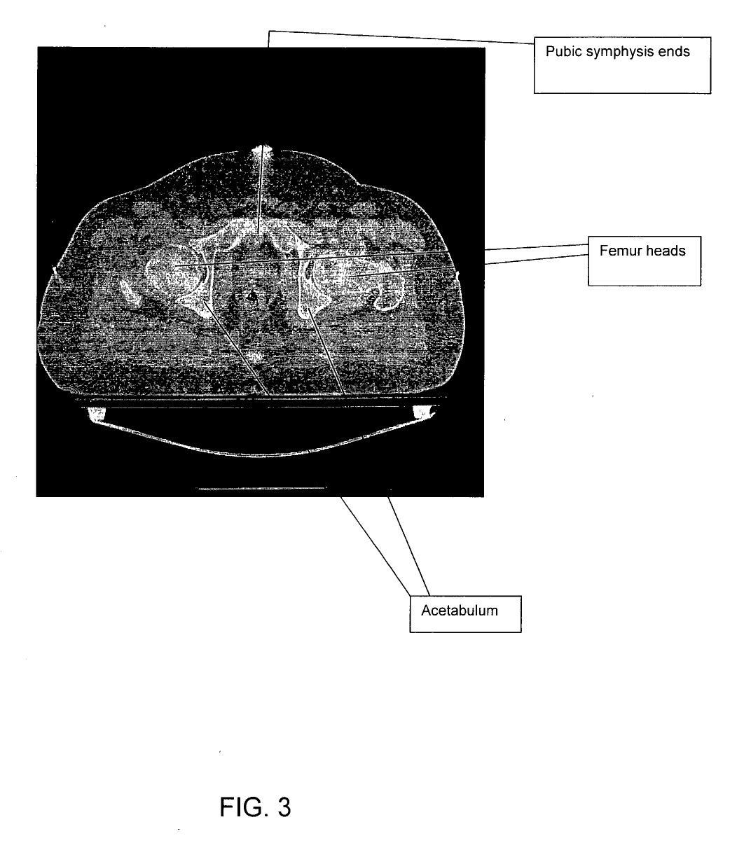

As one moves cranially, different bones join together at different places so that the number of significant bone segments differs from slice to slice. FIG. 3 shows a typical arrangement of bone segments in a slice at the cranial end of the pubic symphysis. In FIG. 3, the superior ramus of pubis bones are joined to the bones of the ischium to form the acetabulum. The pubic bones diverge after the pubic symphysis ends cranially. The number of significant bone segments at a particular slice is thus used by the pubic symphysis locating algorithm 24 to determine the extent of the pubic symphysis.

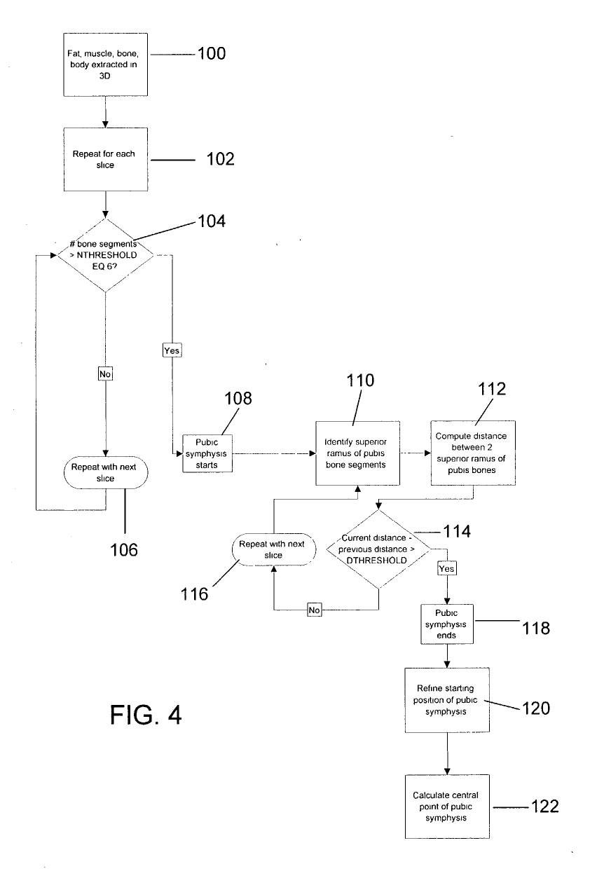

FIG. 4 is a flowchart that illustrates the steps that are carried out by the pubic symphysis locating algorithm 24. For each slice, a connected component analysis is performed on the bone field to label independent regions.

First, at step 100, the fat, muscle, bone and body fields are all extracted in 3D using fixed thresholds. This process is carried out by thresholding each multiple pixel 2D CT image slice that make up the full 3D CT image of the pelvis. The process is repeated for all CT image slices to be analyzed as indicated at step 102.

The remaining steps of the algorithm are carried out slice by slice. At step 104, a query is made whether the number of independent bone segments in the bone field of the image slice which are above a size threshold of NTHRESHOLD (e.g., 250 pixels) is equal to six. If not, then the process is repeated at step 106 for the next image slice. If the number of independent bone segments meeting the size requirement is 6, then it is determined at step 108 that the pubic symphysis starts in that slice. In addition, if the number of bone segments equals six for a particular slice, then the min, max and mean of x and y values for all six bone segments are found. The following steps are also performed.

At step 110, the two bone segments making up the superior ramus of pubis are identified and four x-locations that are the inner and outer x-values (min and max x values) of the two bones are found. Next, at step 112, the distance between the two superior ramus of pubis bones is computed as the distance between the innermost x-location of the two bones. The mid point in the y-direction of the two bones and the mid point in the x-direction of the two innermost points are also saved.

This step of computing the distance between the two superior ramus of pubis bones actually involves a number of sub-steps a follows. At a particular slice, if the number of bone segments is less than 6 but greater than 2, then this implies that some of the bone segments are joined. In order to determine which bone segments have been joined and to determine if this means that the end of the pubic symphysis has been reached, a sorted list of the max y value of the bones segments is created. If the superior ramus of pubis bones were not joined, then the first two entries on this sorted list would be about the same, since the max y value for both these bones should be about the same. In this case the distance between the inner ends of the two bones is calculated as before. The mid-point in the y-direction of the two bones is saved as before. The mid point in the x-direction of the two innermost points is saved.

However, if the difference between the max y values of the 1^{st} two entries on this list is larger than a threshold value YTHRESHOLD (e.g., 10 pixels), this means that the two superior ramus of pubis bones are joined. In this case, the distance between them is zero. If the first entry is close to the first entry in the list for the previous slice, then the two segments of the superior ramus of pubis are joined and separated from the other bones. In this case the mid-point in the y-direction of the two bones is saved as before. However, if the first entry is vastly different from the first entry in the list for the previous slice, the two bones are not separate from the other bones. The mid-point in the y-direction is copied from the value in the previous slice and the mid point in the x-direction of the two innermost points is copied from the value in the previous slice.

At a particular slice, if the number of bones is less than two, then this means that the two superior ramus of pubis bones are joined, in which case the distance between them is zero. In this case, the two segments of the superior ramus of pubis are joined but not separate from the other bones. The mid-point in the x- and the y-direction is copied from the value in the previous slice.

At step 114, if the distance in the current slice minus the distance in previous slice is greater than DTHRESHOLD (10 pixels), then at step 116, the algorithm determines that the cranial end of the pubic symphysis has been reached in the current slice. If not, then at step 118, the algorithm returns to repeat the analysis for the next image slice beginning at step 110.

Occasionally six bone segments can be observed prior to start of the pubic symphysis. Hence, once the start and end of the symphysis are found, the start position is refined at step 120 by rechecking distances between the superior ramus of pubis bones for distances larger than DTHRESHOLD and determining where the difference in distance between adjacent slices falls to below DTHRESHOLD. The first occurrence of this marks the start of the pubic symphysis.

Once the start and end slices of the pubic symphysis are found, the center slice of the pubic symphysis can be found at step 122 as the z-location of the central point of the pubic symphysis. The midpoints in the x- and y-direction of the two innermost points are returned as the x- and y-location of the central point of the pubic symphysis.

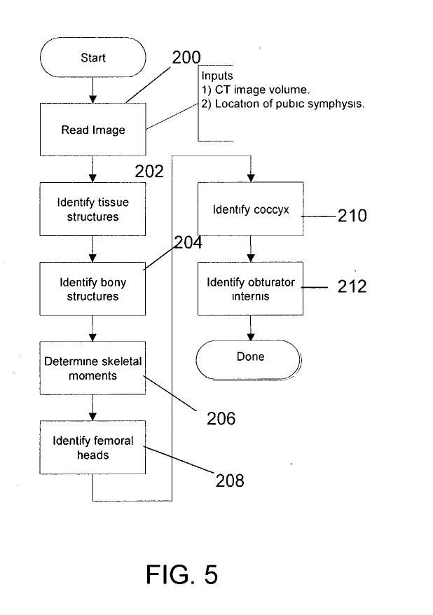

Turning now to the flowchart of FIG. 5, the steps carried out by the bone and muscle locating algorithm 26 are illustrated. First, at step 200, the 3D pixel data that comprises the CT image of the pelvis, is read in along with the previously determined location of the center of the pubic symphysis.

Next, at step 202, the tissue structures of interest are identified by applying a gray-level threshold to the CT data set that is appropriate for muscle. This threshold separates muscle from fat and air. All voxels identified as having a gray-level value greater than this threshold are identified as tissue structures. Likewise, at step 204, the bony structures are identified by applying a gray-level threshold to the CT data set that is appropriate for bone. Then all adjacent voxels in 3D are labeled as separate units and taken together as areas of bone. All neighbors were included when determining adjacency, normally referred to as “8-connectedness”. The term “8-connected” actually has a meaning only for 2D images. It refers to the eight surrounding pixels that are connected and part of the same object because they are adjacent in the four cardinal (up, down, left, and right) and four diagonal directions. In 3D, there are actually 26 8-connected voxels, adding forward and backward cardinal and diagonal directions. For the purposes of this algorithm, only large areas of bone are important, and all regions with fewer than 8000 voxels are discarded.

Next, at step 206, three moments are computed from the segmented bone regions to allow simple orientation of the data volume and rough localization of skeletal structures and associated tissues and organs. First, the centroid of the bone volume is computed. Using the centroid as the origin, two moments are computed by projecting the bone volume onto templates constructed specifically to aid in localizing specific bony structures.

The first template is given by the formula:

f(x)=(2·x′²−1)·x′²e^{-x′}^{²}

where x′=x−x_{c}, and where x_{c} is the x-coordinate of the centroid location. Projection onto this template in each slice measures the amount of bone in the lateral portions of the image, i.e., the femurs and lateral portions of the pelvis. The resulting function of slice has a maximum value near the femoral heads and is used as an aid in localizing them.

The second template is given by the formula:

f(x,y)=y′e^{-(x′}^{²}^{+y}^{²}⁾

where, again, x′=x−x_{c} and y′=y−y_{c} are offsets from the centroid location. Two moments are computed as two separate projections onto this template, one for the left half of the volume and another for the right (determined by the location of the centroid). These projections have large negative values in the region of the pubic symphysis and large positive values in the region of the coccyx, and are used to localize them.

At step 208, a region surrounding the approximate location of each femoral head, identified in the last step, is searched to locate the exact center of the head. This is accomplished by selecting and setting to 1 the voxels with gray values near the bone threshold, setting all others to 0, and convolving the result with a sphere of 4.5 cm radius that approximates the size of the femoral head in the adult male. The center of the femoral head is taken as the peak in the convolution.

Next, at step 210, the skeletal moments and patient orientation are used to determine a search region for the coccyx. Starting several slices cranial to the estimated location of the coccyx, the number of voxels occupied by bone is totaled in each slice progressing caudally. The centroid of the bone voxels in the last slice containing bone is taken as the location of the coccyx.

The location of the femoral heads and coccyx are used to restrict a region for locating the obturator internus muscles in step 212. This region extends from the femoral head to 40% of the distance between the femoral heads in the medio-lateral direction, from the pubic symphysis to the coccyx in the anterior-posterior direction, and from the femoral heads cranially to the top of the bone structures in the cranial-caudal direction.

The inner surface of each obturator internus muscle (one on each side of the pelvis) is then identified using 2D edge detection oriented perpendicular to a line fit through the pelvic bone mass on that side (total bone mass with the sacrum and coccyx removed).

The region medial to the obturator internus and within the limited search region described above defines a region that must contain all structures of interest, namely the bladder, rectum, prostate, and seminal vesicles and no other structures.

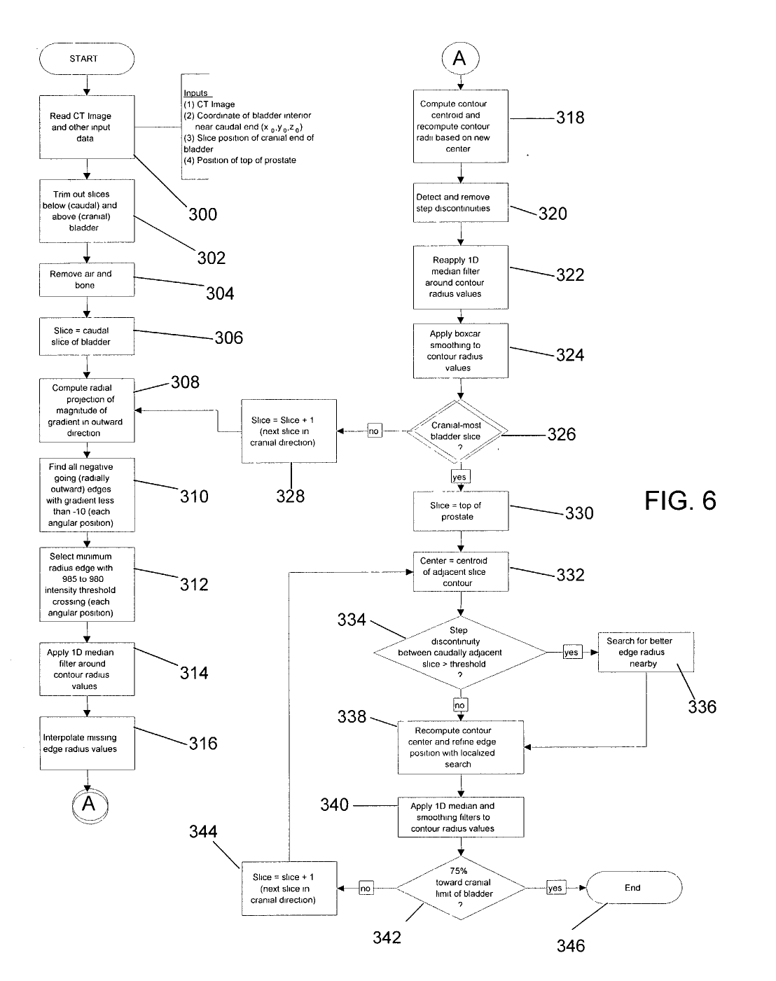

Once the various bone structures, tissue structures and other reference points have been located using the pubic symphysis locating algorithm 24 and the bone and muscle locating algorithm 26, the contouring algorithm 22 can now begin the process of contouring the bladder, rectum, prostate and seminal vesicles. First, the bladder contouring sub-algorithm 28 is executed by carrying out the following steps as illustrated in the flowchart of FIG. 6

At step 300, the input data is read into the algorithm. The input data includes: the CT image of the pelvis; a manually selected point (x₀,y₀) in the bladder interior, near the caudal end of bladder; the slice position of the cranial end of the bladder, which can be manually selected; and, the position (3D point) of the cranial-most extent of the prostate that is determined manually.

Next, at step 302, slices caudal to and cranial to the bladder are ignored since they need not be analyzed further in this sub-algorithm. At steps 304 and 306, air and bone are removed from each image slice by changing the values of selected pixels. Air is known to generate a pixel gray level value of less than 850, while bone is known to generate a pixel gray level value greater than 1100. Thus, air can be eliminated from the image slice by replacing the values of pixels having values less than 850 with a value of 1050, which corresponds to an organ level value. Similarly, bone can be eliminated from the image slice by replacing the values of pixels having values greater than 1100 with a value of 950, which corresponds to a fat level value.

Once the foregoing preliminary steps have been completed for all image slices, the algorithm begins the contouring analysis at step 306 with the first slice at the caudal end of the bladder. First, at step 308, a radial projection of the magnitude of the smoothed gradient is computed in the outward direction about point (x₀,y₀) for all slices. This is done by first computing the gradient in the x and y directions using a convolution with a Gaussian-smoothed gradient kernel. In the preferred embodiment, the kernel size is selected to be 9 by 9, while the Gaussian smoothing is selected to be 1.5 pixels per standard deviation. The radial gradient is computed as the vector projection of the gradient in the direction outward from point (x₀,y₀). This can be visualized as a 2D polar image in the radius-angle plane for each slice.

The next steps are employed to identify points along each radial projection that denote the outer edge of the bladder along that projection. At step 310, all negative-going edges (radially outward) are located that have a radial gradient value of less than or equal to a threshold value, which in the preferred embodiment, is selected to be −10. In the preferred embodiment, this is done for each slice, for radii between 3 and 75 pixel distances, and for 100 equally spaced angles from 0 to 2π. Four-point (bilinear) interpolation is used to compute the gradient value for non-integral pixel coordinates.

In step 312, for each radial projection, the edge with minimum radius that has a mean intensity (image gray level) greater than 985 interior to the radial edge and a mean image intensity less than 980 exterior to the radial edge is selected from the above candidate list. If no such edge exists, the candidate edge for that slice is identified as “missing.” One edge for each angle for each slice is selected. The interior mean intensity is computed over the radius range zero through two pixels inside the edge (inclusive). The exterior mean intensity is computed over the range from the edge radius through 75 pixel distances. This step creates a single closed contour with 100 vertices for each slice.

Next, at step 314, a 1D median filter is applied to the contour radius values of each slice, which removes impulse discontinuities. In the preferred embodiment, the filter window size is 7.

The radius of “missing” edges is linearly interpolated at step 316 based on adjacent edge radii. For example, if one adjacent radial projection has a detected edge at 20 pixel distances and the other adjacent radial projection has a detected edge at 30 pixel distances, the radius of the missing edge will be selected to be 25 pixel distances.

Next, at step 318, the centroid of each contour is computed and the polar intensity and gradient values are recomputed about those new center points. This is done for each slice.

At step 320, step discontinuities in the contour are detected and corrected as follows. Move around the contour from angle 0 through 2π. If the contour radius is greater than or equal to 8 (pixel distances) plus the average of the 3 previous edge radii (in counterclockwise direction), then search for a better edge in the radius range of +/−8 of the average of the 3 previous edge radii. A “better” edge is defined as the radius of minimum radial gradient in that local radius range. In the preferred embodiment, this discontinuity correction is performed counterclockwise and then clockwise for each slice.

Next, at step 322, the 1D median filter is reapplied to the contour radius values of each slice, again, to remove impulse discontinuities. As before, the filter window size is selected to be 7 in the preferred embodiment. A 1D boxcar-smoothing filter is also applied to the contour radius values of each slice at step 324. In the preferred embodiment, the filter window size is selected to be 5.

A query is made at step 326 whether the cranial-most bladder slice is currently being analyzed, which would indicate that the initial analysis procedure is complete. If the answer is no, then the next slice in the cranial direction is retrieved for analysis at step 328 and the algorithm returns to step 308. If the answer is yes, then the image slice that contains the top of the prostate is selected at step 330 for further analysis.

For the “middle” slices, between the cranial extent of the prostate and the 75% of the way proceeding cranially through the bladder, the following additional steps are performed because these slices need additional refinement based on adjacent slice information. At step 332, the center of the current slice is set equal to the centroid of the adjacent slice contour. The contour radii and the radial gradient values are then recomputed using the center point from the caudally adjacent slice.

At step 334, for each angular position in the contour, the contour radius is compared to the contour radius of the caudally adjacent slice. If the step discontinuity between the two exceeds a threshold, then the algorithm searches at step 336 for a better edge radius nearby. In the preferred embodiment, if the radius is more than 15 pixel distances smaller for a given angle, then the algorithm will search for a better edge within 15 pixel distances of the caudally adjacent radius. Similarly, if the radius is more than 10 pixel distances larger for a given angle, than the algorithm will search for a better edge within 10 pixel distances of the caudally adjacent radius. A “better edge” here is defined as the radius of minimum radial gradient in that local radius range.

At step 338, the contour centroids and contour radius values are recomputed based on the new centroids. The contour radii are refined by finding the minimum gradient value within a +/−4-pixel distance.

Step 340 is another filtering step which includes applying a 1D median filter (filter window size 11) to the contour radius values of each slice to remove impulse discontinuities, followed by application of a 1D boxcar-smoothing filter (filter window size 5) to the contour radius values of each slice.

Finally, at step 342, a query is made whether the current slice is 75% of the way toward the cranial limit of the bladder. If not, the next slice is retrieved at step 344 and the algorithm returns to step 308. If yes, the bladder contour algorithm 26 is finished and the autocontouring algorithm 22 proceeds to the next sub-algorithm, which is the rectum contouring algorithm 30.

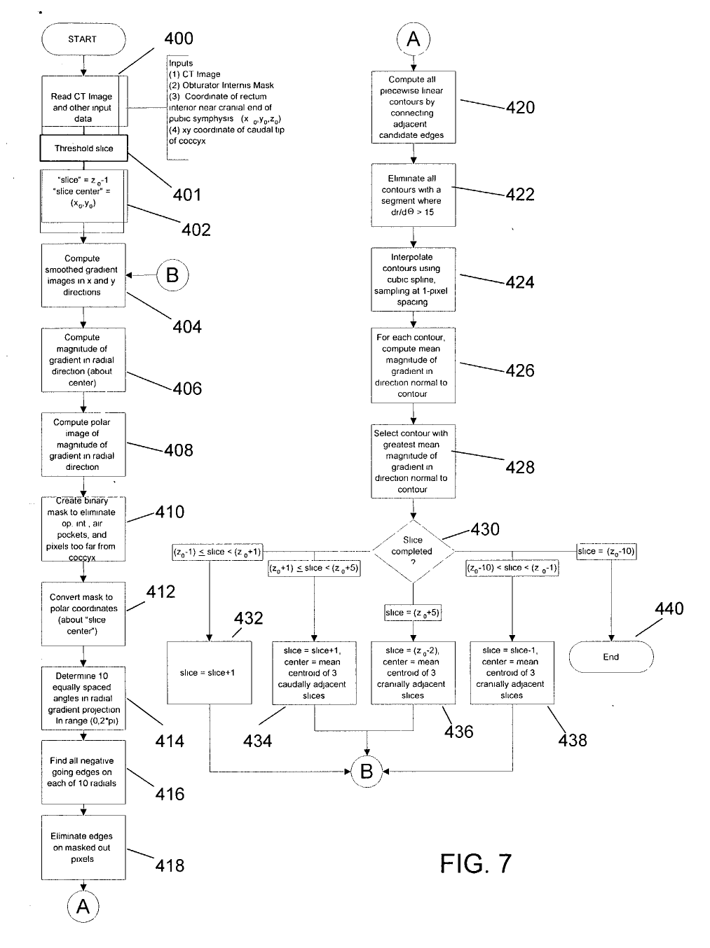

A flowchart of the steps that are carried our by the rectum contouring algorithm 30 is illustrated in FIG. 7. First, at step 400, the CT image of the abdomen and various other input data are read. In addition to the image, the input data includes: a manually selected xyz-point (x₀,y₀,z₀) in the rectum interior, near the cranial end of the pubic symphysis; the 3D binary mask indicating the voxels belonging to the obturator internis; and, the xy-point indicating the caudal tip of the coccyx (the later two are generated by the bone and muscle locating algorithm 26).

Step 401 is a preliminary thresholding step in which the CT image slice is clipped to be limited to pixel values in a range between 900 and 1000. Next, at step 402, slice z₀−1 is selected fro analysis and the slice center is set equal to (x₀,y₀).

At step 404, the x-gradient and y-gradient 2D images are computed. This is done by convolving the slices with a Gaussian-smoothed-gradient kernel. The kernel size is 7-by-7 pixels. The Gaussian smoothing width is two pixels per standard deviation.

At step 406, the radial projection of the gradient is computed about the center point (x₀,y₀). This is computed as the vector magnitude of the gradient in the radial direction at each image pixel

From the above radial projection image, step 408 is to compute the 2D polar image with the radius axis in the range 0 to 60 CT image pixels in 1-pixel increments, and the angle axis in the range 0 to 2π radians in 2π/100 increments. Four-point (bilinear) interpolation is used for non-integral coordinates in the CT image.

The next step 410 is to create a binary mask to eliminate the obturator internis, air pockets and pixels too far from the coccyx. This process is carried out as follows: 1) start with 2D image of all one-values; 2) mask out pixels strictly outside a 50-pixel radius circle, bottom-centered on the xy-position of the coccyx (algorithm input); 3) mask out all pixels identified as belonging to the obturator internis by the obturator internis mask (algorithm input); and, 4) mask out the pixels enclosed within the minimum-area convex region enclosing all pixels below gray-level 700 (determined to be air) and the center point (x₀,y₀). At step 412, the mask is converted to polar coordinates centered about the point (x₀,y₀).

The next group of steps serves to identify edges of the rectum along a number of radial projections. First, at step 414, ten equally spaced angles are selected in the radial gradient projection between 0 and 2π radians that include the 0-radian angle. At step 416, all negative going edges on each of these ten radials are located using the radial gradient projection. Any edges that are “masked out” in the radial projection computed above are eliminated during step 418.

In the preferred embodiment, a technique known as multiple hypothesis testing (MHT) is applied during the next steps of the rectum contouring algorithm 30. In MHT, multiple possible combinations of variables are generated. Known characteristics of correct combinations of the variables are then applied to the collection of combinations to eliminate combinations that do not possess these characteristics. This technique is applied in the preferred embodiment of the rectum contouring algorithm 30 in the following manner.

At step 420, all possible combinations of the candidate edges are computed, one per angular position. This creates a collection of all possible closed piecewise-linear contours for the slice. It should be noted that many of these contours will not actually represent the contour of the rectum itself since not every negative going edge along the radial projections in the slice represents an actual edge of the rectum. To filter out unlikely candidates in the collection of all possible contours, all contours that have a segment where the derivative of the radius with respect to angle (dr/dθ) is greater than 15 are eliminated at step 422. What this does is to eliminate any contours that have curvatures that are too sharp to represent the outer contour of the rectum. At step 424, the remaining contours are interpolated using a cubic spline at a sampling resolution of 1-pixel distance between contour vertices. Finally, at step 426, the magnitude of the gradient in the direction normal to the contour is computed for each remaining contour at each vertex. The contour with the highest mean magnitude value (averaged across all contour vertices) is then selected as the contour that actually represent the contour of the rectum.

Once the foregoing analysis is completed for the current slice, a determination is made at step 430 as to how to proceed next, which depends on the identity of the current slice. If the current slice is z₀−1, z₀ or z₀+1, the slice is incremented by one at step 432 and the algorithm returns to step 404 using the center point (x₀,y₀) for all radial gradient and polar computations. If the current slice is z₀+1, z₀+2, z₀+3 or z₀+4, the slice is incremented by one at step 434 and the algorithm returns to step 404 using the centroid of the contour for adjacent slice in the caudal direction for all radial gradient and polar computations. If the current slice is z₀+5, the slice is set to z₀−2 at step 436 and the algorithm returns to step 404 using the centroid of the contour for adjacent slice in the caudal direction for all radial gradient and polar computations. If the current slice is z₀−2 through z₀−9, the slice is decremented by one at step 438 and the algorithm returns to step 404 using the centroid of the contour for adjacent slice in the cranial direction for all radial gradient and polar computations. Finally, if the current slice is z₀−10, the algorithm is finished at step 440.

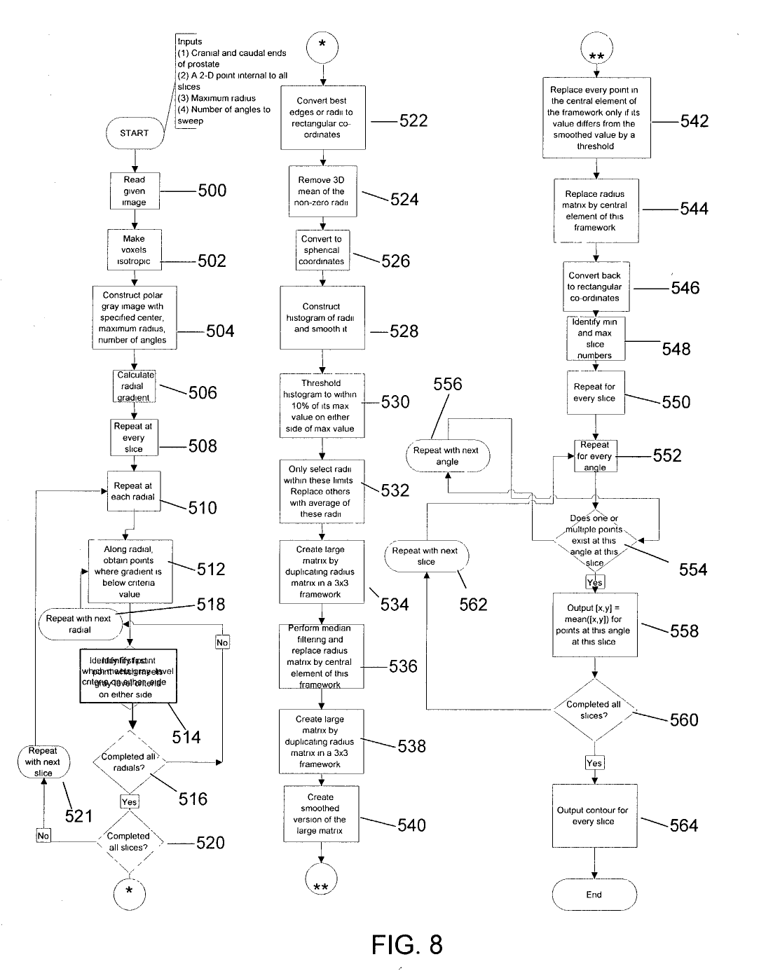

The next sub-algorithm to be executed is the prostate contouring algorithm 32. A flowchart illustrating the steps carried out by this algorithm is shown in FIG. 8. The first step 500, is to input data including the CT image, the cranial and caudal ends of the prostate (the caudal end is in the same location as the caudal end of the pubic symphysis as determined by the pubic symphysis locating algorithm 24), a maximum radius of the prostate and a center which is a point internal to all the slices containing the prostate.

Once the data is loaded, the algorithm begins by converting the image to one with isotropic voxels at step 502. A polar gray image is then constructed at step 504 with the specified center and radius using a specified number of angles to sweep. The radial gradient projection is calculated at step 506 for the given slice using a smoothed gradient kernel. These steps are repeated at each slice and at each radial as indicated at 508 and 510.

At step 512, points are identified along each radial where the radial gradient projection falls below a particular threshold. At each of these points, the gray level on either side is checked at step 514. If the gray level on the side closer to the center is above a certain threshold, and the gray level beyond the edge (i.e. on the other side) falls to below a certain threshold, then the edge is considered to be a valid border point of the prostate. The first valid border point along each radial is identified. If no edge point along a certain radial meets either gradient or gray level criteria, then no border point is marked for that particular radial. Next, at step 516, a query is made whether all of the radials have been analyzed. If not, at step 518, the process is repeated with the next radial beginning again at step 512.

Once all radials have been analyzed for a particular slice, the algorithm goes to step 520 to inquire whether all slices have been analyzed. If not, the next slice is retrieved at step 521 and the algorithm returns to step 510 for analysis of the next slice.

If the analysis of all slices has been completed, the algorithm proceeds to step 522, where the obtained edges or best radii are converted from cylindrical coordinates to rectangular coordinates and then at step 524, the 3D mean of the non-zero radii is removed. This is achieved by calculating the center of the retained edges (non-zero) in [x,y,z] coordinates and subtracting this from the rectangular values. At step 526, the edges are converted to spherical co-ordinates.

A histogram is constructed of the remaining radii at step 528. The maximum of the histogram (after smoothing) is identified and the points where it falls to below 10% of its value on either side are identified at step 530. At step 532, only radii within these two limits are retained, while other radii are replaced by an average of the radii within these limits.

At step 534, the radii are converted to a radius matrix of dimensions n_angles×n_slices. A large matrix is constructed by duplicating the radius matrix 3 times row wise and column wise (i.e. in a 3×3 matrix framework).

Median filtering with a filter width of 15 is performed on this large matrix at step 536, which effectively takes care of border conditions because of the duplication of the radius matrix. The new radius matrix is extracted as the central portion of the large matrix.

The large matrix is again constructed at step 538 and a smoothed version of the large matrix is constructed at step 540. If the original value on the large matrix in the central portion is different from the smoothed version by a threshold, the original value is replaced by the smoothed value at step 542.

Again, the radius matrix is extracted as the central portion of the large matrix at step 544. The spherical coordinates (with updated radii) are converted back to rectangular co-ordinates at step 546 and the minimum and maximum values of the slice are identified at step 548. The foregoing procedure is repeated for every image slice as indicated at 550.

As indicated at 552, the algorithm loops through these slice values. For every slice value in this range, at every angle, the algorithm checks if a point exists on that slice at step 554. If no points exist, then no point is output for that angle for that slice and the process is repeated with the next angle at step 556. If multiple points exist, then the mean [x,y] of these points is output as the final point for that angle for that slice at step 558.

At query step 560, if analysis of all slices has not been completed, then the algorithm repeats the process with the next slice at step 562 and returns to step 552. If the analysis of all slices is complete, then the points are written out as contours for every slice at step 564 and this sub-algorithm is finished.

The next sub-algorithm that is executed by the autocontouring algorithm 22 is the seminal vesicle contouring algorithm 34. This algorithm actually relies heavily on the information that is generated by all of the previous sub-algorithms because it operates more on an exclusion basis rather than on an identification basis. The overall strategy is to contour the bladder, rectum, and prostate independently, then contour the seminal vesicles making use of the contours of these three organs.

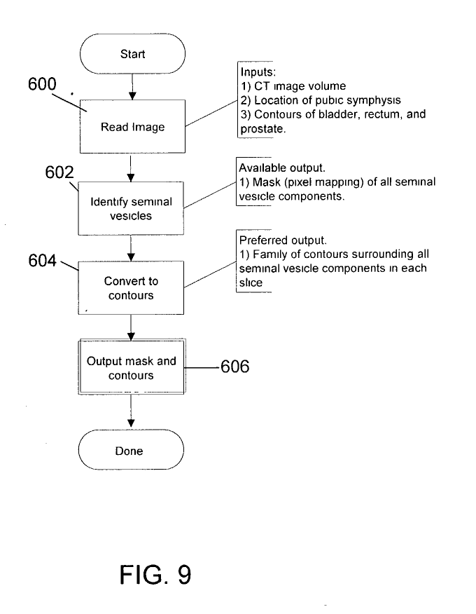

A flowchart illustrating the steps carried out by the seminal vesicle contouring algorithm is illustrated in FIG. 9. The first step 600 is to input data from each of the previously described sub-algorithms along with the 3D pixel data that comprises the CT images of the pelvis. This data includes: the locations of the pubic symphysis and the various structures located by the bone and muscle locating algorithm 26, and the contours of the bladder, rectum and the prostate.

The region medial to the obturator internus that is identified by the bone and muscle locating algorithm 26 defines a region that must contain all structures of interest, namely the bladder, rectum, prostate, and seminal vesicles, and no other structures. Since the seminal vesicles are highly variable in both size and shape, they are identified at step 602 through a process of elimination. All remaining voxels must belong to seminal vesicles. The seminal vesicles are taken as the connected tissue regions within the search region defined above, excluding all tissues identified as bladder, rectum, or prostate by other portions of the algorithm. The overall mask of voxels belonging to the seminal vesicles may be smoothed through a morphological opening operation for better visual appearance and (perhaps) more appropriate contouring.

Finally, the mask produced in the last step can be converted to contours at step 604 by extracting the boundary of the mask in each slice. The mask and contours are then output at step 606.

The final sub-algorithm carried out during execution of the autocontouring algorithm 22 is the integration algorithm 36. Since the bladder, rectum and prostate algorithms 28, 30 and 32 operate independently of one another, the contours they each compute will likely not agree completely with one another. In addition, it is likely that information derived from one algorithm, may be used to improve the results generated by another algorithm. For these reasons, the results of the four organ contouring algorithms are combined by the integration algorithm 36.

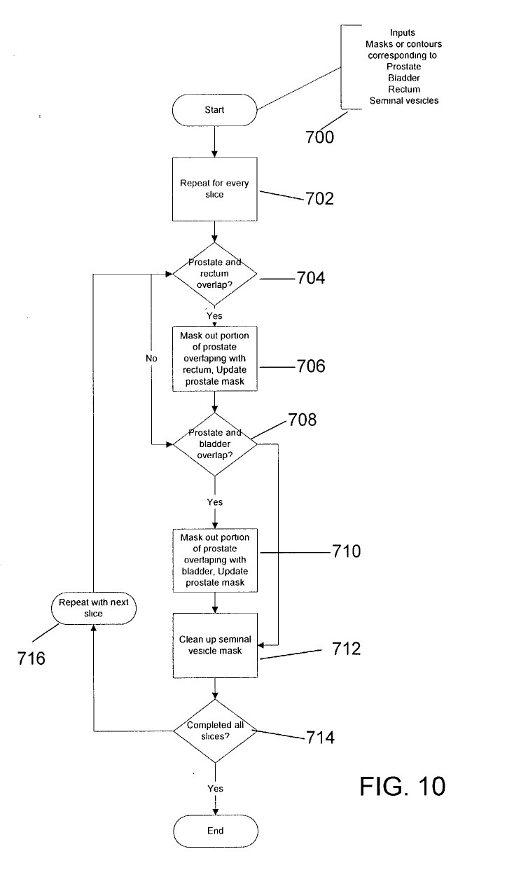

A flowchart containing the steps carried out by the integration algorithm 36 is illustrated in FIG. 10. First, at step 700, the four segmented masks or contours corresponding to them are read. As indicated at 702, this process is repeated for every image slice.

At step 704, a query is made whether there is an overlap between the prostate and rectum contours. For resolving conflicts between rectum and prostate, the rectum is always considered more likely to be correct, since the rectum estimate is considered more accurate than the prostate estimate. Thus, if there is a conflict between these two contours, the portion of the prostate that overlaps the rectum is masked out at step 706 and the prostate mask is updated accordingly.

The next query at step 708 is whether the prostate and the bladder overlap. For resolving conflicts between bladder and prostate, the bladder is always considered more likely to be correct, since the bladder estimate is considered more accurate than the bladder estimate. Thus if there is an overlap between these two contours, the algorithm proceeds to step 710 and mask out the portion of the prostate that overlaps the bladder and the prostate mask is updated accordingly.

At step 712, in the case of seminal vesicles, some “cleanup” or post processing operation is necessary since the initial results may contact a large number of disjoint regions and a number of small spurious regions. In order to do this post processing, a morphological open operation, followed by a median filtering operation, followed by a Euclidean distance transform operation is performed on the mask representing the seminal vesicle regions. Final contours are then generated from the updated masks.

Finally, at step 714, a query is made whether processing of all slices is completed. If not, the next slice is input at step 716 and the algorithm returns to step 704 to repeat the processing. If processing of all slices is completed, the algorithm is finished.

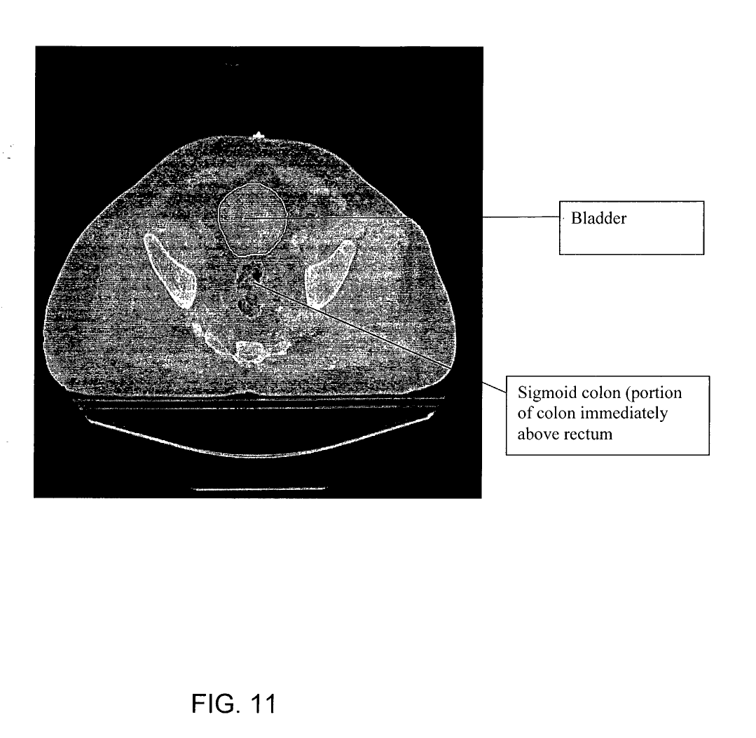

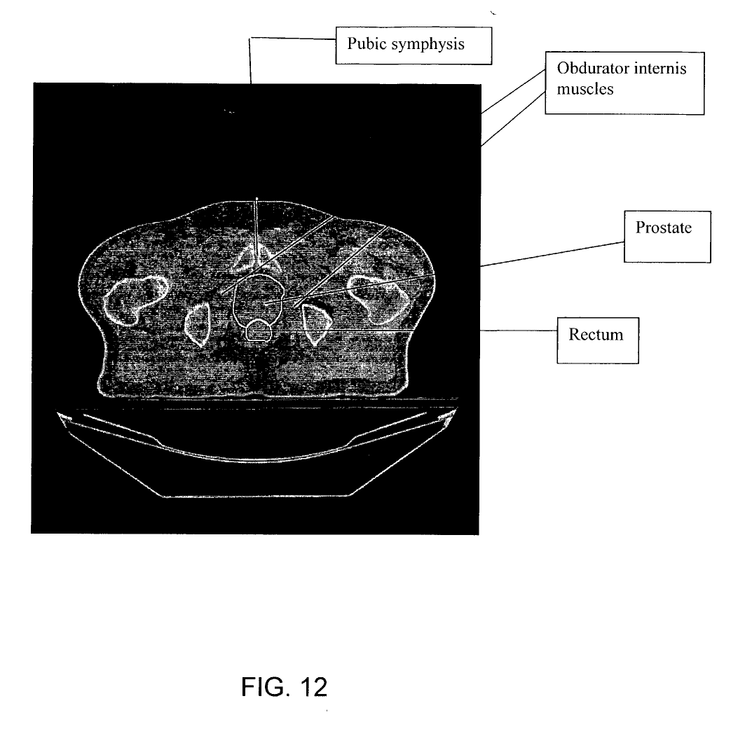

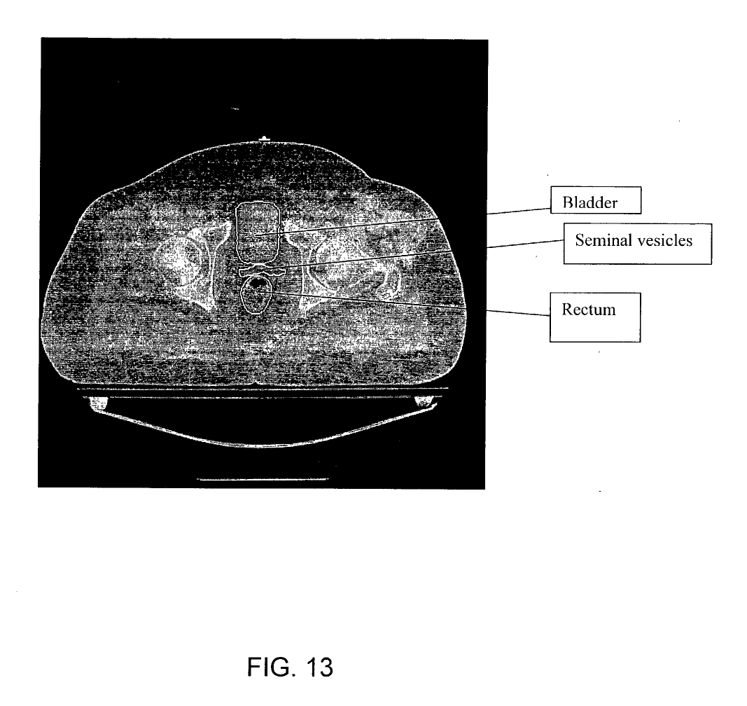

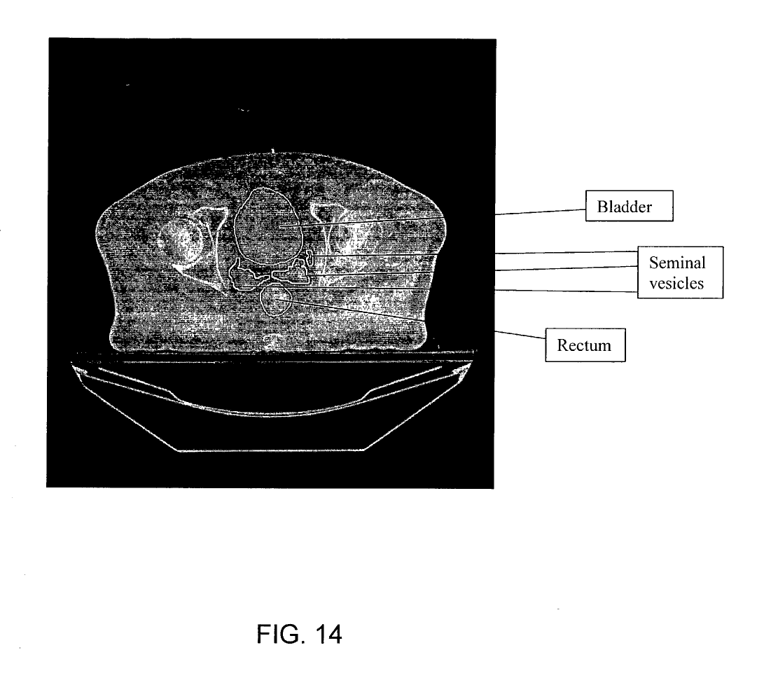

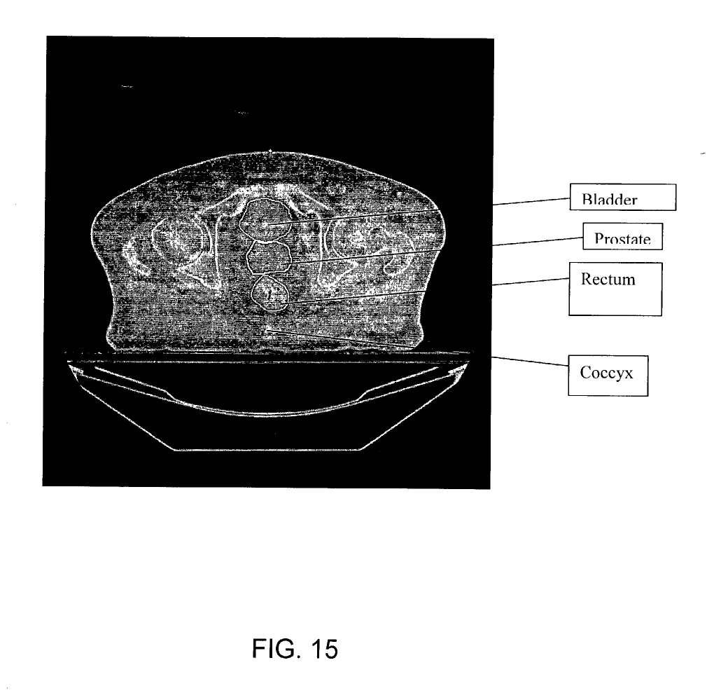

Sample results obtained with the autocontouring algorithm 22 are illustrated in the CT image slices of FIGS. 11-15 in which the various contoured organs and other structures are identified. FIG. 11 is a slice showing the contour of the bladder and its relationship with the sigmoid colon. In FIG. 12, the contours of the prostate and the rectum are both shown along with the pubic symphysis and the obdurator internis muscles. FIGS. 13 and 14 show the contours of the bladder, seminal vesicles and the rectum at different slices. Finally, FIG. 15 shows the contours of the bladder, prostate and rectum along with the coccyx.

Although the invention has been disclosed in terms of a preferred embodiment and variations thereon, it will be understood that numerous additional variations and modifications could be made thereto without departing from the scope of the invention as set forth in the attached claims. For example, the multiple hypothesis testing technique that is employed in the rectum contouring algorithm could be employed in the prostate and bladder contouring algorithms as well as in other, non-edge based techniques for contouring or region identification. Further, while the preferred embodiment is directed specifically toward contouring the prostate and other nearby organs, the inventive concepts could be employed for contouring other anatomical structures in various regions of the body

What is claimed is:

1. A computer-based method for contouring anatomical structures in an image comprising the steps of:
obtaining a multiple pixel digital image of an organic body, each of said pixels having a pixel value that is equal to a gray scale level of said pixel; and
executing a algorithm to locate at least a first contour of an anatomical structure in said image, said algorithm carrying out the steps of:
identifying a plurality of groups of said pixels, each of which potentially defines a contour of an anatomic structure in said image; and
selecting a group of pixels from said plurality as most likely to define an anatomic structure in said image based upon one or more known characteristic traits of an anatomic structure.

2. The method of claim 1, wherein said step of identifying a plurality of groups of pixels further comprises:
identifying a first point in said image that is positioned within an anatomic structure whose contour is to be identified;
calculating a plurality of radial gradient projections, each of which describes the gradient directed away from said first point in a different direction;
for each radial gradient projection, identifying whether one or more edge points exist along said gradient that potentially correspond to an edge of an anatomic structure; and
generating a plurality of possible contours of said anatomic structure by connecting each edge point on each radial gradient projection with edge points on adjacent radial projections, the edge points in each of said possible contours being defined by a corresponding one of said plurality of groups of said pixels.

3. The method of claim 2, wherein said step of selecting a group of pixels from said plurality as most likely to define an anatomic structure in said image includes the step of eliminating any of said groups of pixels that correspond to contours having curvature values that exceed a threshold value.

4. The method of claim 3, wherein said step of selecting a group of pixels from said plurality as most likely to define an anatomic structure in said image further includes the step of selecting a group of pixels corresponding to a contour with the greatest mean magnitude of gradient in a direction normal to said contour.

5. The method of claim 1, wherein said anatomical structures are selected from the group including bones, muscles and organs.

6. The method of claim 5, wherein said anatomical structures are male human organs selected from the group including the bladder, the prostate and the rectum.

7. The method of claim 1, wherein said image is a medical image.

8. The method of claim 7, wherein said medical image is a CT image.

9. A computer-based method for contouring anatomical structures in an image comprising the steps of:
obtaining a multiple pixel digital image of an organic body, each of said pixels having a pixel value that is equal to a gray scale level of said pixel; and
executing a algorithm to locate at least a first contour of an anatomical structure in said image, said algorithm carrying out the steps of:
identifying a first point in said image that is positioned within an anatomic structure whose contour is to be identified;
calculating a plurality of radial gradient projections, each of which describes the gradient directed away from said first point in a different direction;
for each radial gradient projection, identifying whether an edge point exists along said gradient projection that potentially corresponds to an edge of said anatomic structure; and
generating a contour of said anatomic structure by connecting any said edge point on each radial gradient projection with any said edge points on adjacent radial projections.

10. The method of claim 9, wherein said anatomical structures are selected from the group including bones, muscles and organs.

11. The method of claim 10, wherein said anatomical structures are male human organs selected from the group including the bladder, the prostate and the rectum.

12. The method of claim 9, wherein said image is a medical image.

13. The method of claim 12, wherein said medical image is a CT image.

14. A computer-based method for contouring a male prostate in a digital image of a male's pelvic region comprising the steps of:
obtaining a multiple pixel digital image of a male's pelvic region, each of said pixels having a pixel value that is equal to a gray scale level of said pixel, said image including at least an image of a bladder, a rectum and a prostate; and
executing a algorithm to locate a contour of said prostate, said algorithm carrying out the steps of:
analyzing said image to identify a potential contour of said bladder;
analyzing said image to identify a potential contour of said rectum;
analyzing said image to identify a potential contour of said prostate; and
analyzing said potential contours of said bladder, rectum and prostate to generate a refined contour of said prostate.

15. The method of claim 14, wherein at least one of said steps of analyzing said image to identify a potential contour of said bladder, rectum and prostate further comprise the steps of:
identifying a first point in said image that is positioned within an organ whose contour is to be identified;
calculating a plurality of radial gradient projections, each of which describes the gradient directed away from said first point in a different direction;
for each radial gradient projection, identifying whether an edge point exists along said gradient projection that potentially corresponds to an edge of said organ; and
generating a contour of said organ by connecting any said edge point on each radial gradient projection with any said edge points on adjacent radial projections.

16. The method of claim 15, wherein said image is a medical image.

17. The method of claim 16, wherein said medical image is a CT image.

18. The method of claim 14, wherein at least one of said steps of analyzing said image to identify a potential contour of said bladder, rectum and prostate further comprise the steps of:
executing a algorithm to locate at least a first contour of an organ in said image, said algorithm carrying out the steps of:
identifying a plurality of groups of said pixels, each of which potentially defines a contour of said organ in said image; and
selecting a group of pixels from said plurality as most likely to define said organ in said image based upon one or more known characteristic traits of said organ.

19. The method of claim 18, wherein said step of identifying a plurality of groups of pixels further comprises:
identifying a first point in said image that is positioned within said organ whose contour is to be identified;
calculating a plurality of radial gradient projections, each of which describes the gradient directed away from said first point in a different direction;
for each radial gradient projection, identifying whether one or more edge points exist along said gradient that potentially correspond to an edge of said organ; and
generating a plurality of possible contours of said organ by connecting each edge point on each radial gradient projection with edge points on adjacent radial projections, the edge points in each of said possible contours being defined by a corresponding one of said plurality of groups of said pixels.

20. The method of claim 19, wherein said step of selecting a group of pixels from said plurality as most likely to define said organ in said image includes the step of eliminating any of said groups of pixels that correspond to contours having curvature values that exceed a threshold value.

21. The method of claim 20, wherein said step of selecting a group of pixels from said plurality as most likely to define said organ in said image further includes the step of selecting a group of pixels corresponding to a contour with the greatest mean magnitude of gradient in a direction normal to said contour.

22. The method of claim 18, wherein said image is a medical image.

23. The method of claim 22, wherein said medical image is a CT image.

24. The method of claim 14, further comprising the step of analyzing said image to identify a potential contour said male's seminal vesicles.

25. A system for contouring anatomical structures in an image comprising:
a source of images to be analyzed, each said image comprising a multiple pixel digital image of an organic body, each of said pixels having a pixel value that is equal to a gray scale level of said pixel;
a computer including a memory for storing receiving and storing said images and a processor for analyzing said images, said processor being programmed with an algorithm for analyzing said images, said algorithm carrying out the steps of:
identifying a plurality of groups of said pixels, each of which potentially defines a contour of an anatomic structure in said image; and
selecting a group of pixels from said plurality as most likely to define an anatomic structure in said image based upon one or more known characteristic traits of an anatomic structure.

26. The system of claim 25, wherein said step of identifying a plurality of groups of pixels further comprises:
identifying a first point in said image that is positioned within an anatomic structure whose contour is to be identified;
calculating a plurality of radial gradient projections, each of which describes the gradient directed away from said first point in a different direction;
for each radial gradient projection, identifying whether one or more edge points exist along said gradient that potentially correspond to an edge of an anatomic structure; and
generating a plurality of possible contours of said anatomic structure by connecting each edge point on each radial gradient projection with edge points on adjacent radial projections, the edge points in each of said possible contours being defined by a corresponding one of said plurality of groups of said pixels.

27. The system of claim 26, wherein said step of selecting a group of pixels from said plurality as most likely to define an anatomic structure in said image includes the step of eliminating any of said groups of pixels that correspond to contours having curvature values that exceed a threshold value.

28. The system of claim 27, wherein said step of selecting a group of pixels from said plurality as most likely to define an anatomic structure in said image further includes the step of selecting a group of pixels corresponding to a contour with the greatest mean magnitude of gradient in a direction normal to said contour.

29. The system of claim 25, wherein said anatomical structures are selected from the group including bones, muscles and organs.

30. The system of claim 29, wherein said anatomical structures are male human organs selected from the group including the bladder, the prostate and the rectum.

31. The system of claim 25, wherein said image is a medical image.

32. The system of claim 31, wherein said medical image is a CT image.

33. A system for contouring anatomical structures in an image comprising:
a source of images to be analyzed, each said image comprising a multiple pixel digital image of an organic body, each of said pixels having a pixel value that is equal to a gray scale level of said pixel;
a computer including a memory for storing receiving and storing said images and a processor for analyzing said images, said processor being programmed with an algorithm for analyzing said images, said algorithm carrying out the steps of:
identifying a first point in said image that is positioned within an anatomic structure whose contour is to be identified;
calculating a plurality of radial gradient projections, each of which describes the gradient directed away from said first point in a different direction;
for each radial gradient projection, identifying whether an edge point exists along said gradient projection that potentially corresponds to an edge of said anatomic structure; and
generating a contour of said anatomic structure by connecting any said edge point on each radial gradient projection with any said edge points on adjacent radial projections.

34. The system of claim 33, wherein said anatomical structures are selected from the group including bones, muscles and organs.

35. The system of claim 34, wherein said anatomical structures are male human organs selected from the group including the bladder, the prostate and the rectum.

36. The system of claim 33, wherein said image is a medical image.

37. The system of claim 36, wherein said medical image is a CT image.

38. A system for contouring a male prostate in a digital image of a male's pelvic region comprising:
a source of medical images to be analyzed, each said image comprising a multiple pixel digital image of a male's pelvic region, each of said pixels having a pixel value that is equal to a gray scale level of said pixel, said image including at least an image of a bladder, a rectum and a prostate; and
a computer including a memory for storing receiving and storing said images and a processor for analyzing said images, said processor being programmed with an algorithm for locating a contour of said prostate, said algorithm carrying out the steps of:
analyzing said image to identify a potential contour of said bladder;
analyzing said image to identify a potential contour of said rectum;
analyzing said image to identify a potential contour of said prostate; and
analyzing said potential contours of said bladder, rectum and prostate to generate a refined contour of said prostate.

39. The system of claim 38, wherein at least one of said steps of analyzing said image to identify a potential contour of said bladder, rectum and prostate further comprise the steps of:
identifying a first point in said image that is positioned within an organ whose contour is to be identified;
calculating a plurality of radial gradient projections, each of which describes the gradient directed away from said first point in a different direction;
for each radial gradient projection, identifying whether an edge point exists along said gradient projection that potentially corresponds to an edge of said organ; and
generating a contour of said organ by connecting any said edge point on each radial gradient projection with any said edge points on adjacent radial projections.

40. The system of claim 39, wherein said image is a medical image.

41. The system of claim 40, wherein said medical image is a CT image.

42. The system of claim 38, wherein at least one of said steps of analyzing said image to identify a potential contour of said bladder, rectum and prostate further comprise the steps of:
executing a algorithm to locate at least a first contour of an organ in said image, said algorithm carrying out the steps of:
identifying a plurality of groups of said pixels, each of which potentially defines a contour of said organ in said image; and
selecting a group of pixels from said plurality as most likely to define said organ in said image based upon one or more known characteristic traits of said organ.

43. The system of claim 42, wherein said step of identifying a plurality of groups of pixels further comprises:
identifying a first point in said image that is positioned within said organ whose contour is to be identified;
calculating a plurality of radial-gradient projections, each of which describes the gradient directed away from said first point in a different direction;
for each radial gradient projection, identifying whether one or more edge points exist along said gradient that potentially correspond to an edge of said organ; and
generating a plurality of possible contours of said organ by connecting each edge point on each radial gradient projection with edge points on adjacent radial projections, the edge points in each of said possible contours being defined by a corresponding one of said plurality of groups of said pixels.

44. The system of claim 43, wherein said step of selecting a group of pixels from said plurality as most likely to define said organ in said image includes the step of eliminating any of said groups of pixels that correspond to contours having curvature values that exceed a threshold value.

45. The system of claim 44, wherein said step of selecting a group of pixels from said plurality as most likely to define said organ in said image further includes the step of selecting a group of pixels corresponding to a contour with the greatest mean magnitude of gradient in a direction normal to said contour.

46. The system of claim 45, wherein said image is a medical image.

47. The system of claim 46, wherein said medical image is a CT image.

48. The system of claim 38, wherein said algorithm further carries out the step of analyzing said image to identify a potential contour said male's seminal vesicles.
